(19) United States
(12) Patent Application Publication
(10) Pub. No.: US 2007/0221475 A1
(43) Pub. Date: Sep. 27, 2007

(54) Unscrambling conveyor

(76) Inventors: James Halsey, (US); Eric Glazier, (US)

Correspondence Address: FROST BROWN TODD, LLC, 2200 PNC CENTER, 201 E. FIFTH STREET, CINCINNATI, OH, 45202, US

(21) Appl. No.: 11/728,972

(22) Filed: Mar. 27, 2007

Related U.S. Application Data
(60) Provisional application No. 60/786,623, filed on Mar. 27, 2006.

(51) Int. Cl. B65G 13/02

(52) U.S. Cl. 198/442; 198/786

(57) ABSTRACT

A conveyor for unscrambling articles into single file has three lanes with the rollers of the outer lanes skewed toward the middle lane. The middle lane runs at a different speed than the outer lanes, and may have skewed rollers. The unscrambling conveyor may include several modules sequentially arranged, with a speed change within the lanes between the modules.

### RELATED APPLICATION

This application claims the priority of provisional patent application Ser. No. 60/786,623, titled Unscrambling Conveyor, filed on Mar. 27, 2006, the disclosure of which is incorporated herein by reference.

### TECHNICAL FIELD

The present invention relates generally to conveyors, and more particularly to conveyors used to unscramble articles into single file. The invention will be disclosed in connection with, but not necessarily limited to, a conveyor having a plurality of adjacent lanes comprised of power driven skewed rollers.

### BRIEF DESCRIPTION OF THE DRAWINGS

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a top view of a conveyor constructed in accordance with the teachings of the present invention.

FIG. 2 is a top view of the first section of the conveyor of FIG. 1.

FIG. 3 is a top view of the second section of the conveyor of FIG. 1.

FIG. 4 is a top view of the third section of the conveyor of FIG. 1.

FIG. 5 is a perspective view of the conveyor section illustrated in FIG. 3.

FIG. 6 is a perspective view of the conveyor frame used for the individual sections illustrated in FIGS. 2, 3 and 4, without the rollers, drive belt and end frame members.

FIG. 7 is an enlarged, fragmentary, perspective view illustrating the path of the drive belt.

FIG. 8 is an enlarged, fragmentary perspective view illustrating the mounting of a center lane roller, relative position of an outer lane roller, and a pressure sheave, taken at line 8-8 of FIG. 2.

FIG. 9 is an enlarged, fragmentary top view of the illustration of FIG. 8.

FIG. 10 is an enlarged, fragmentary, side cross-sectional view of the illustration of FIG. 8.

FIG. 11 is an enlarged, fragmentary, cross-sectional perspective view of a pressure sheave mounted to a frame.

FIG. 12 is an enlarged, fragmentary, exploded perspective view of the pressure sheave of FIG. 11.

FIG. 13 is a perspective view of the exit end of a conveyor section, illustrating the inner frame and mounting rail.

FIG. 14 illustrates rollers in their fanned orientation.

FIG. 15 illustrates rollers at the entrance are fanned out.

FIG. 16 illustrates a bracket bridging conveyor sections.

Reference will now be made in detail to the present preferred embodiment of the invention, an example of which is illustrated in the accompanying drawings.

### DETAILED DESCRIPTION

In the following description, like reference characters designate like or corresponding parts throughout the several views. Also, in the following description, it is to be understood that terms such as front, back, inside, outside, and the like are words of convenience and are not to be construed as limiting terms. Terminology used in this patent is not meant to be limiting insofar as devices described herein, or portions thereof, may be attached or utilized in other orientations. Referring in more detail to the drawings, an embodiment of the invention will now be described.

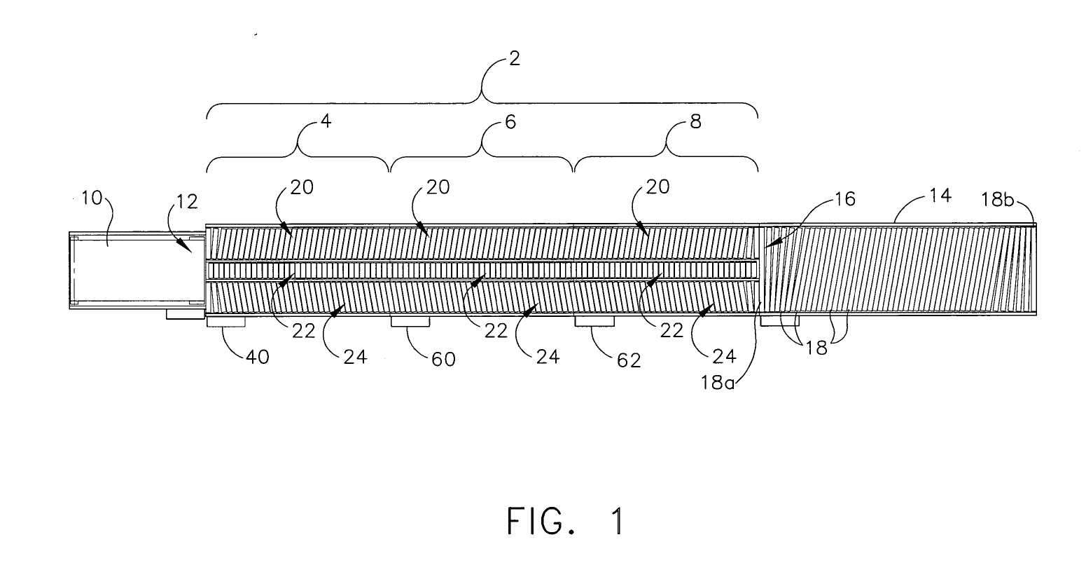

Referring to FIG. 1, there is illustrated unscrambling conveyor, generally indicated at 2, constructed in accordance with some or all of the teachings of the present invention. In the embodiment depicted, conveyor 2 includes three conveyor sections, 4, 6 and 8. Infeed conveyor 10 delivers articles (including by way of non-limiting example, cartons or packages) carried by its conveying surface to entrance 12 of conveyor 2. Infeed conveyor 10 is depicted as a belt conveyor, but may be of any suitable configuration such as rollers, wheels or any other conveyor type suitable for delivering articles to entrance 12. Infeed conveyor 12 may operate at any speed suitable to the speeds of conveyor 2, such as, in the embodiment depicted, 70-90 feet per minute.

Downstream conveyor 14 receives articles from exit 16 from conveyor 2. Downstream conveyor 14 is depicted as power driven conveyor with a plurality of rollers 18 (for simplicity only a few of the rollers are specifically identified as 18). As can be seen in FIG. 1, the first roller 18a and last roller 18b are not skewed providing a transition from the upstream conveyor 2 and to the next conveyor (not shown) downstream of downstream conveyor 14. Rollers 18 in between roller 18a and roller 18b may be skewed as shown, fanning out to the skewed orientation at the entrance of downstream conveyor 14 and fanning back to the non-skewed orientation at the exit of downstream conveyor 14. The skew angle of the embodiment depicted in FIG. 1 may be 8°, or any suitable angle. Downstream conveyor 14 may include a vertical guide of any suitable surface to assist with edge aligning articles received from conveyor 2, such as skate wheels, moving belt or stationary surface. Although downstream conveyor 14 is depicted as a powered conveyor with skewed rollers, it may be of any suitable configuration such as tapered rollers, wheels or any other conveyor type suitable for receiving articles from exit 16. Optionally, however, downstream conveyor 14 may not function to edge align articles. Downstream conveyor 14 may operate at any speed suitable to the speeds of conveyor 2, such as, in the embodiment depicted, 360 feet per minute.

As seen in FIG. 1, conveyor 2 is depicted as having three adjacent lanes 20, 22 and 24, each having a plurality of longitudinally aligned rollers. As illustrated, outside lanes 20 and 24 are skewed toward the center of conveyor 2 so as to advance articles toward the center of conveyor 2. Center lane 22 may be skewed to either side. The direction of the skew may be dictated by the configuration of the conveyor downstream of exit 16. For example, in the embodiment depicted, the rollers in center lane 22 are skewed in the same direction as rollers 18. Although sections 4, 6 and 8 are depicted as powered conveyors with skewed cylindrical rollers, they may be of any suitable configuration such as tapered rollers, wheels or any other suitable configuration and construction.

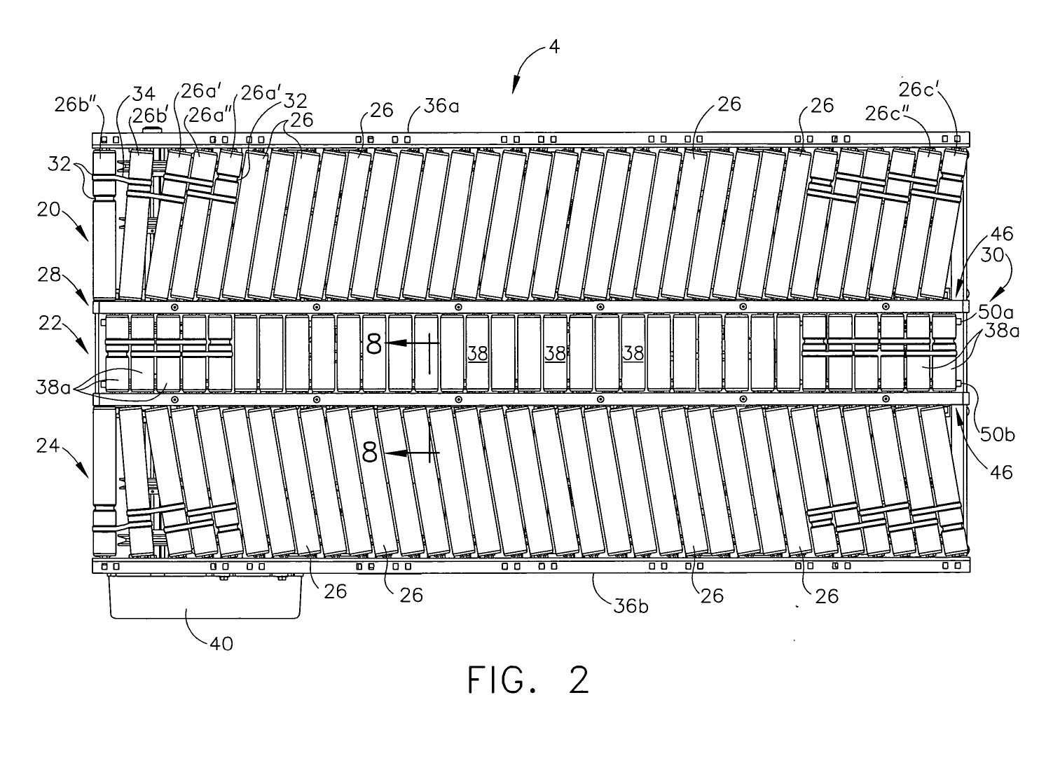

In the embodiment depicted, sections 4, 6 and 8 are constructed modularly, with each section being the same except for orientation of the rollers at the section's entrance and of the rollers at the section's exit, although the present invention may be practiced without modular sections. Referring also to FIG. 2, which depicts section 4, lanes 20 and 24 are depicted as mirror images of each other (along the longitudinal axis) with each section having a plurality of rollers 26 which form lanes 20 and 24. In the embodiment depicted, the rollers have a diameter of about 1.9 inches and are located on about 2.12 inch centers. As will be described below, in the embodiment depicted, rollers 26 of each lane 20 and 24 are driven by a respective belt disposed under rollers 26, guided by a respective drive and idler at either end and urged against rollers 26 by a plurality of sheaves (none of which are seen in FIGS. 1 and 2). Because the drive belt falls away from the rollers adjacent entrance 28 and exit 30 of section 4, rollers 26a′, 26a″, 26b″ and 26b″ are not directly driven by the drive belt, instead being driven by adjacent rollers in a well know manner through O-belts 34 disposed in grooves 32. As can be seen, grooves 32 of rollers 26a′ and 26b′ are spaced differently than grooves 32 on rollers 26a″ and 26b″. This allows alignment of the grooves between adjacent rollers 26a′, 26a″, 26b′and 26b″ to accommodate O-belts 34. For clarity, only rollers 26a′, 26a″, 26b′ and 26b″ of lane 20 at entrance 28 have been numbered, although the corresponding rollers of lane 24, and at the exit of lanes 20 and 24 are depicted in the same configuration.

In the embodiment depicted, rollers 26, 26a′ and 26a″ are generally uniformly skewed at an angle of about 9°, having an offset of about 2.12 inches over a roller length of about 12.75 inches, although any suitable skew angle may be used. In the embodiment depicted, the illustrated skew angle will accommodate a drive belt disposed perpendicular to the axis of rotation of the rollers, the drive belt being disposed at an angle to the longitudinal axis of the conveyor sections. A greater skew angle on outside lanes 20 and 24 may allow sections 4, 6 and 8 to be shorter.

Since entrance 28 of section 4 is entrance 12 of conveyor 2, in the embodiment depicted, it is disposed adjacent a conveyor having an exit which is perpendicular to the longitudinal axis of conveyor 2. Rollers 26b′ and 26b″ are fanned out at entrance 28 to transition from perpendicular (0° skew) of roller 26b″ to the maximum skew starting, in the embodiment depicted, with roller 26a′ adjacent roller 26b′. The fanning out maintains the gaps between the ends of rollers 26b″, 26b′ and 26a′ (adjacent roller 26b′) adjacent outer frames 36a and 36b, respectively, at acceptably small sizes. A structure may be disposed immediately upstream of entrance 12 in any gap between infeed conveyor 10 and rollers 26b″ and the first of rollers 38a.

Since exit 30 is disposed adjacent section 6 which, in the embodiment depicted, has skewed rollers (as described below) at its entrance, rollers 26c′ and 26c″ do not need to be fanned back to perpendicular.

Center lane 22 is formed of a plurality of rollers 38 which are driven by a drive belt (not shown in FIG. 2) arranged substantially the same as the drive belts driving lanes 20 and 24. Rollers 38a are not directly driven by the drive belt, instead being driven by adjacent rollers in a well know manner through O-belts. In the embodiment depicted, as will be described below, the respective pulleys that drive the three drive belts for lanes 20, 22 and 24 are mounted on a common drive shaft (not seen in FIGS. 1 and 2) powered by drive 40, although any suitable drive arrangement may be utilized, including individual drives for each lane.

In the embodiment depicted, rollers 38 are skewed toward outer frame 36b, matching the skew direction of downstream conveyor 14 in the embodiment depicted. In the embodiment depicted, rollers 38 are skewed at an angle of about 4.2°, having an offset of about 0.5 inches across a roller length of about 6.81 inches. As will be described below, the ends of rollers 38 and 38a are offset from the adjacent ends of rollers 26, 26a′, 26a″, 26b′ and 26b″ to avoid interference with the axles.

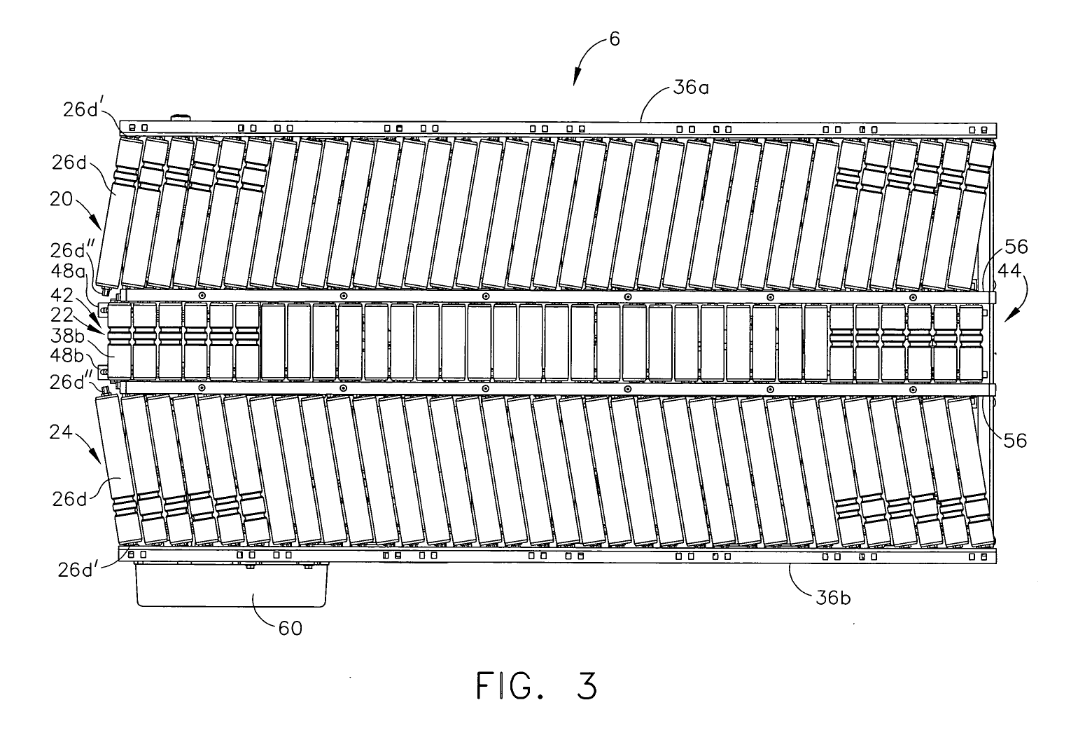

Referring to FIG. 3, section 6 is illustrated (with O-belts omitted for clarity). In the embodiment depicted, as mentioned above, section 6 is constructed substantially the same as section 4 except for the orientation of the rollers at entrance 42. As seen in FIG. 3, entrance rollers 26d of lanes 20 and 24 are skewed, with outer ends 26d′ being respectively mounted in outer frames 36a and 36b. Due to the skew, inner ends 26d″ are disposed upstream beyond entrance 42, lacking support by section 6. Referring also to FIG. 2, rollers 26d extend beyond entrance 42, which is adjacent exit 30, with ends 26d″ being supported by section 4 at area 46, which will be described in more detail below. This avoids needing to fan rollers out or fan rollers back at the entrance and exit of each section 4, 6 and 8.

Roller 38b is disposed generally at exit 30 of section 4 and entrance 42 of section 6. The location of the ends of roller 38b are disposed at a location that, in the embodiment depicted, are supported by respective brackets 48a and 48b. One end of each bracket 48a and 48b is supported by section 4 at locations 50a and 50b, and the other end is supported by section 6, as is described in more detail below.

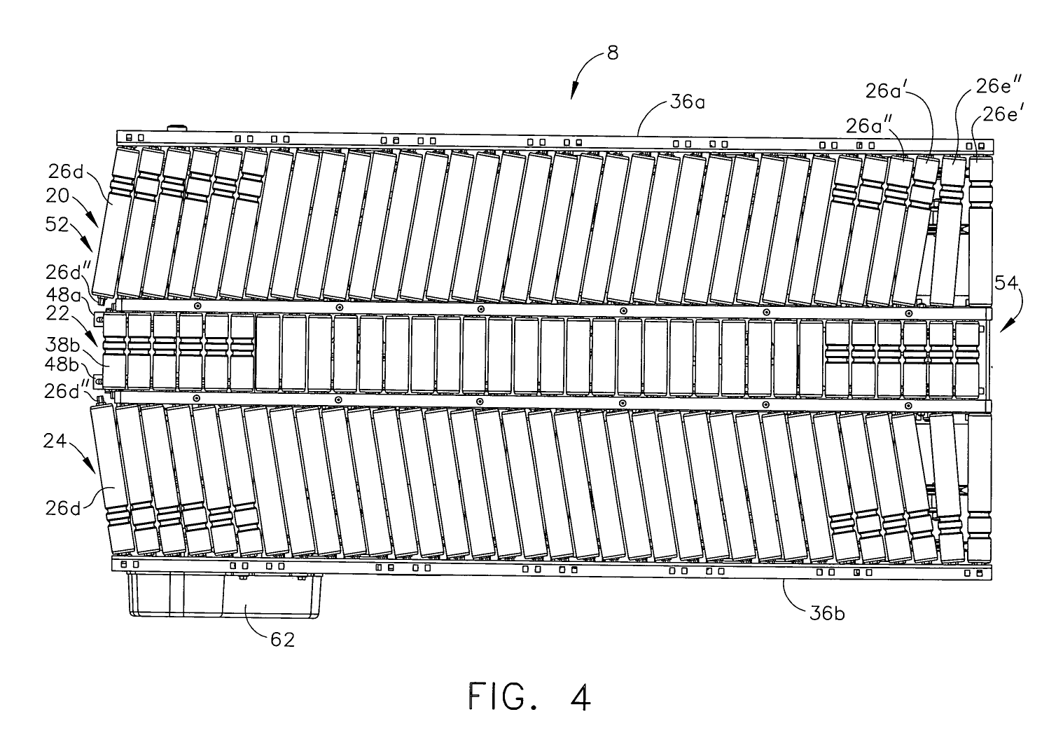

Referring to FIG. 4, section 8 is illustrated (with O-belts omitted for clarity). In the embodiment depicted, as mentioned above, section 8 is constructed substantially the same as sections 4 and 6, except for the orientation of the rollers at exit 54. As seen in FIG. 4, entrance rollers 26d of section 8 are disposed the same as entrance rollers 26d of section 6, with inner ends 26d″ being respectively disposed upstream beyond entrance 52, being supported by section 6 at area 56. Roller 38b of section 8, is disposed generally at exit 44 of section 6 and entrance 52 of section 8, supported by brackets 48a and 48b that span sections 6 and 8 in the same manner as described above.

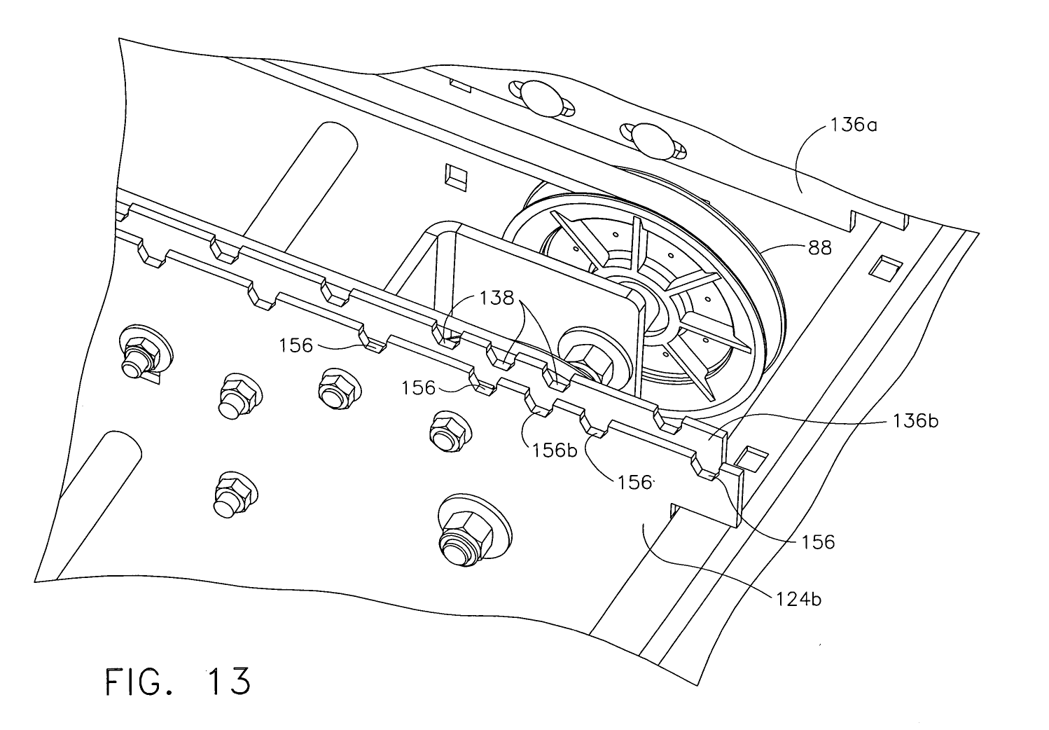

Since exit 54 of section 8 is exit 16 of conveyor 2, in the embodiment depicted, it is disposed adjacent a conveyor having an entrance which is perpendicular to the longitudinal axis of conveyor 2. Rollers 26e′ and 26e″ of lane 20, and the corresponding rollers of lane 24, are fanned at exit 54 to transition from the maximum skew to perpendicular to the longitudinal direction. The fanning maintains the gaps between the ends of rollers 26e″, 26e′ and 26a′ (adjacent roller 26e″) adjacent inner frames 124a and 124b (see FIG. 13) at acceptably small sizes.

In the embodiment depicted, section 4, 6 and 8 are driven independently of each other, with each having respective drive units 40, 60, 62, although any suitable drive arrangement may be used. Each section may be connected to the adjacent section in any suitable means. Each section may be assembled identical to each other, with the rollers oriented as for section 6, and the final configuration of the rollers made during installation. In such instance, an installation kit can be utilized for each interface between sections of conveyor 2, containing two 26d rollers, a 38b roller, brackets 48a and 48b, and any necessary fasteners and O-belts. During installation, the rollers at the entrance and exit of conveyor 2 may be fanned out as described above, using the installation kit for the interfaces between sections. In the embodiment depicted, each section is six feet long, although any length may be used. More or less than three sections may be used as suitable. It is noted that any entrance configuration of rollers that is complementary to the configuration of the upstream conveyor may be used.

Each downstream section 6 and 8 are preferably, as in the embodiment depicted, operated at a higher speed than the upstream section 4 and 6 feeding it. The speeds of outer lanes 20 and 24 within each section 4, 6 and 8 may be, as in the embodiment depicted, the same as each other, with center lane 22 being operated at a higher speed than the outer lanes.

With outer lanes 20 and 24 being skewed toward the center, articles are advanced toward the middle. When articles which are side by side reach the faster running center lane 22, the article reaching center lane 22 first will tend to be advanced ahead of the other article. When articles reach the higher speed downstream section 6 or 8, gaps may be introduced between articles, promoting unscrambling.

In the embodiment depicted, in section 4, the speed of outer lanes 20 and 24 is 180 feet per minute, and the speed of center lane 22 is 240 feet per minute; in section 6, the speed of outer lanes 20 and 24 is 240 feet per minute, and the speed of center lane 22 is 320 feet per minute; in section 8, the speed of outer lanes 20 and 24 is 300 feet per minute, and the speed of center lane 22 is 400 feet per minute. Other speeds and ratios between the sections as well between lanes may be used.

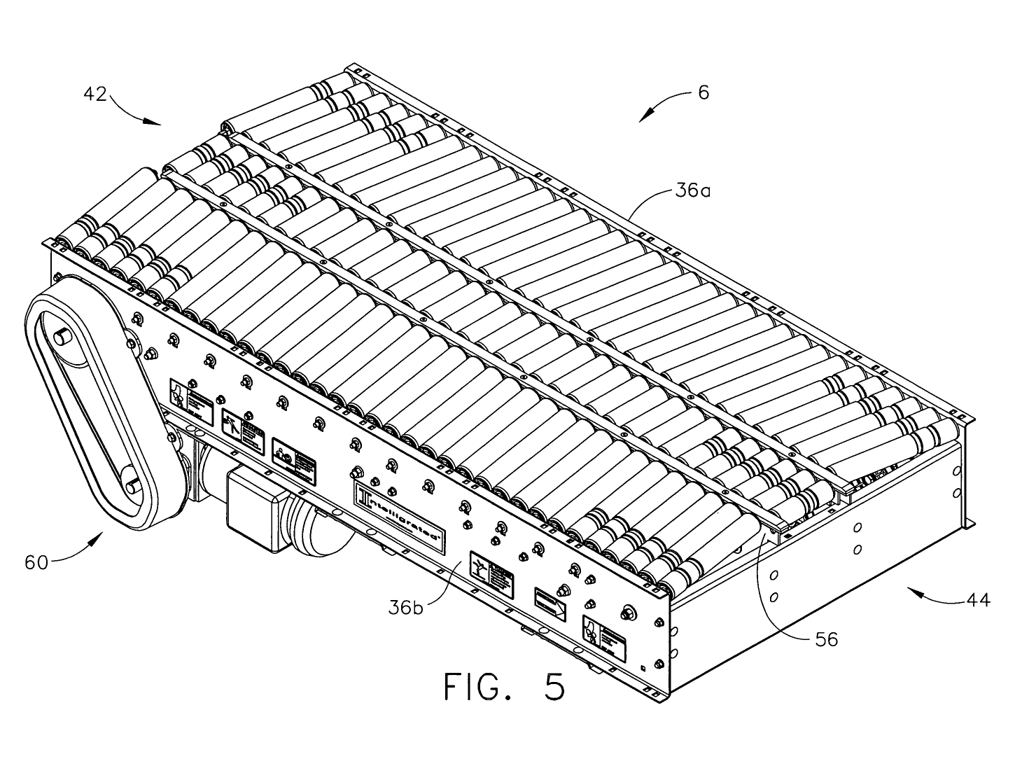

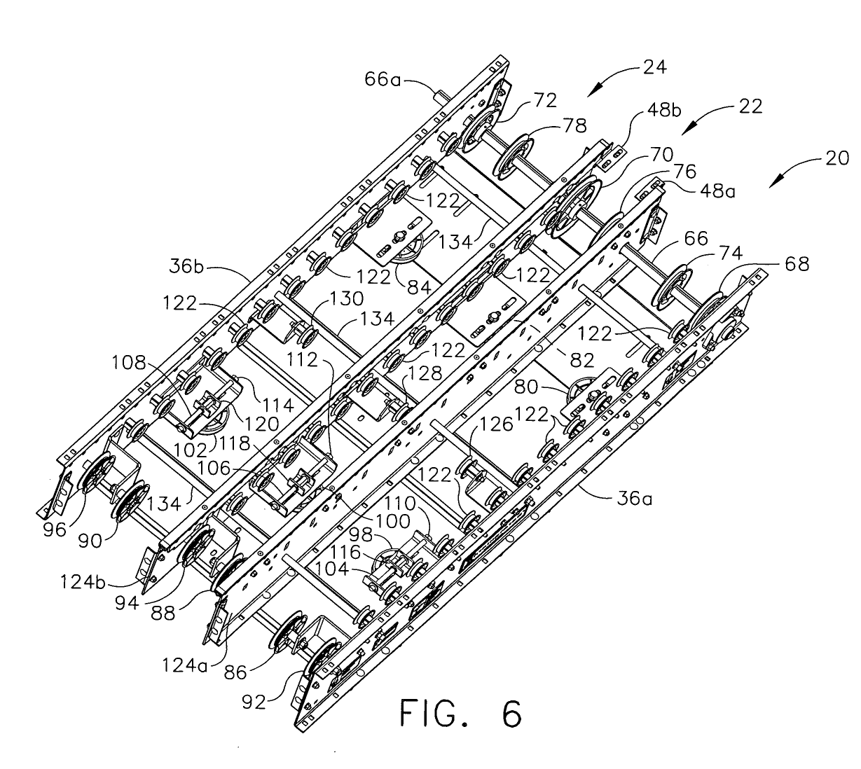

Referring now to FIG. 5, section 6 is illustrated as a perspective view. FIG. 6 is a perspective view of the conveyor frame used for the individual sections illustrated in FIGS. 2, 3 and 4, without the rollers, drive belt and end frame members. As seen in FIG. 6, drive shaft 66 is disposed, in the embodiment depicted, at the entrance end of the section. Drive shaft 66 has respective drive pulleys 68, 70 and 72 non-rotatably mounted thereto aligned with each lane 20, 22 and 24, respectively. The relative diameter of drive pulleys 68, 70 and 72 may establish the speed ratio between each lane. Drive shaft 66 is rotatably supported by outer frames 36a and 36b, with end 66a extends beyond outer frame 36b for connection to a respective drive unit (not shown). Idler pulleys 74, 76 and 78 are rotatably carried by drive shaft 66. Spaced from the entrance, horizontal pulleys 80, 82 and 84 disposed respectively in lanes 20, 22 and 24. At the exit end, idler pulleys 86, 88 and 90, and idler pulleys 92, 94 and 96 are disposed respectively in lanes 20, 22 and 24.

Spaced from the exit, horizontal pulleys 98, 100 and 102 are disposed respectively in lanes 20, 22 and 24. Horizontal pulleys 98, 100 and 102 are each mounted to a respective adjustment mechanism 104, 106 and 108, which respectively includes a longitudinally oriented threaded member 110, 112 and 114 which may be rotated to move a respective bracket 116, 118 and 120 to which the respective pulleys 98, 100 and 102 are mounted. The respective axes of rotation of pulleys 98, 100 and 102 may be adjusted longitudinally independent of each other.

Also seen in FIG. 6 are a plurality of spaced apart rotatable sheaves 122 mounted within each lane 20, 22 and 24, along the inside faces of outer frames 36a and 36b, and from the inner surface of inner frame 124b. Respective sheaves 126, 128 and 130 are disposed in lanes 20, 22 and 24, respectively, generally in the middle between the ends.

The pulleys and sheaves define the path of the drive belts (not shown in FIG. 6). Referring only to outside lane 24, which exemplifies the drive belt arrangement for lanes 20 and 22, drive pulley 72 is aligned with pressure sheaves 122 carried by outer frame 36b. Pulleys 96 and 90 are aligned with horizontal pulley 102. Sheave 130 and pulley 78 are generally aligned with pulley 90. Pulley 78 and drive pulley 72 are aligned with horizontal pulley 84.

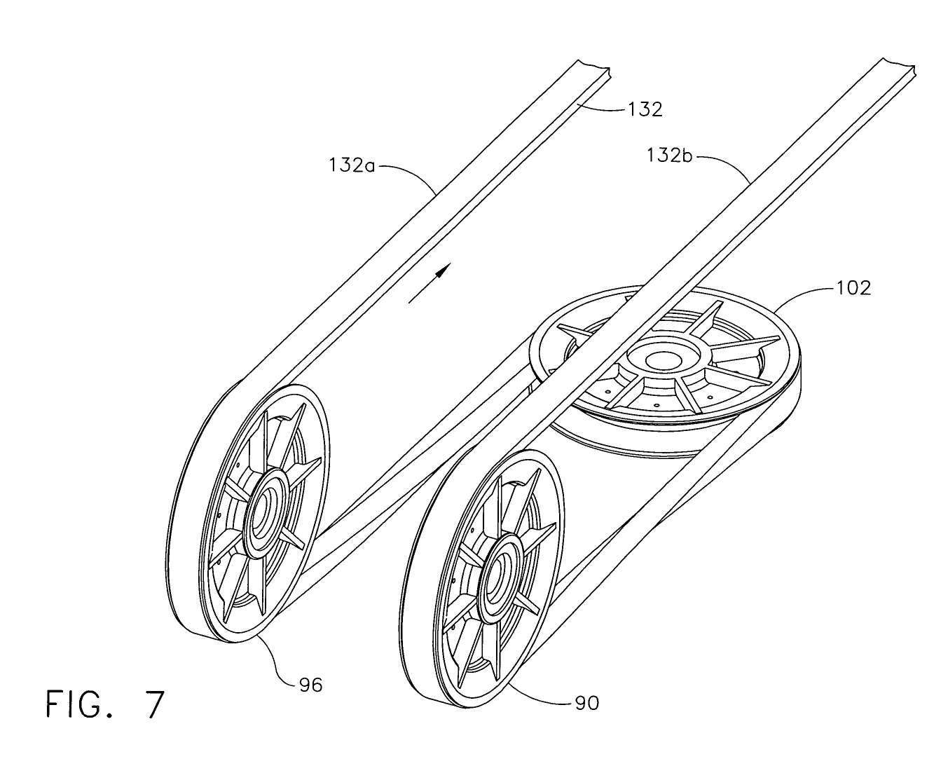

Referring to FIG. 7, which illustrates an enlarged, fragmentary, perspective view illustrating one end of the path of drive belt 132, which in the embodiment depicted, is shown as a V-belt, although any suitable shape may be used. Side 132a of belt 132 travels in the direction indicated. The end configuration of endless drive belt 132 illustrated in FIG. 7 is identical to the opposite end of belt 132, except that pulley 96 is replaced by drive pulley 72. Tension and slack of belt 132 may be adjusted by adjustment mechanism 108, moving pulley 102 longitudinally in the desired direction. Portion 138a is supported by sheaves 122 near outer frame 36b, with sheaves 122 urging portion 138a into driving engagement with rollers 26. At the entrance end, portion 138a is driven by drive pulley 72. From there, belt 132 extends around pulley 84 and idler pulley 78. Now portion 132b, belt 132 returns to pulley 90, supported by pulley 130. With this configuration, belt 132 avoids having any frame cross members 134 extend through the center of belt 132, making installation easier.

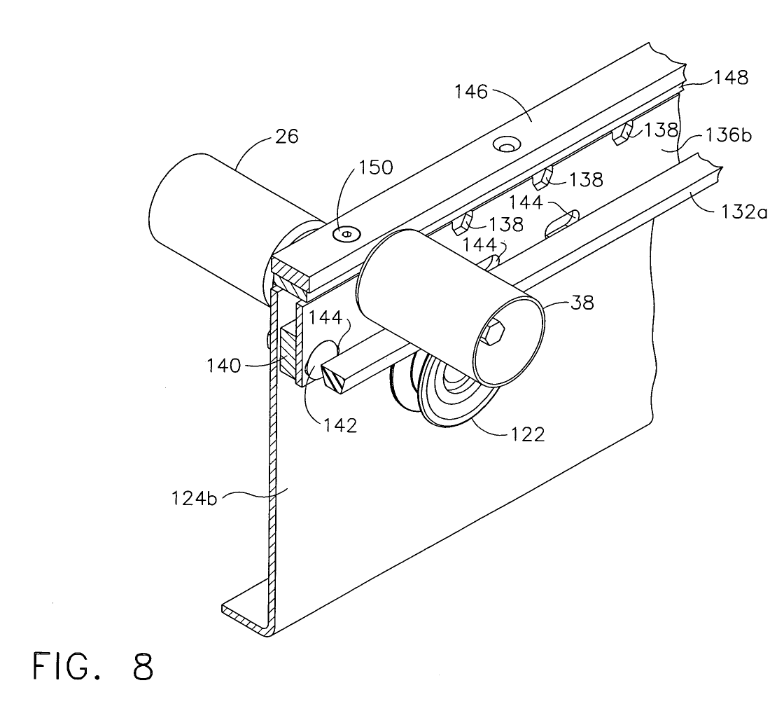

Referring to FIG. 8, there is shown an enlarged, fragmentary perspective view illustrating the mounting of center lane roller 38, relative position of an outer lane roller, and a pressure sheave, taken at line 8-8 of FIG. 2. It is noted, in FIGS. 8, 9 and 10, that although the ends of the illustrated components, such as rollers 26 and 38 and inner frame 124b, are not illustrated utilizing broken lines, the view is of a section taken at line 8-8 of FIG. 2. Rollers 26 and 38 have axles extending from either end, which may be solid or a stub axle extending there from, which may be of any suitable shape, such as hexagonal which functions to prevent rotation of the axle in its support. As seen in FIG. 8, inner frame 124b carries mounting rail 136b, which extends the length of the conveyor section, either as a single, unitary member as in the embodiment depicted, or as multiple members. Mounting rail 136b includes a plurality of spaced apart roller support openings 138 shaped complementarily to receive the axle support of rollers 38 to provide support to one end thereof. Although not visible in FIG. 8, inner frame 124b includes a plurality of spaced apart roller support openings to support the inner end of rollers 26.

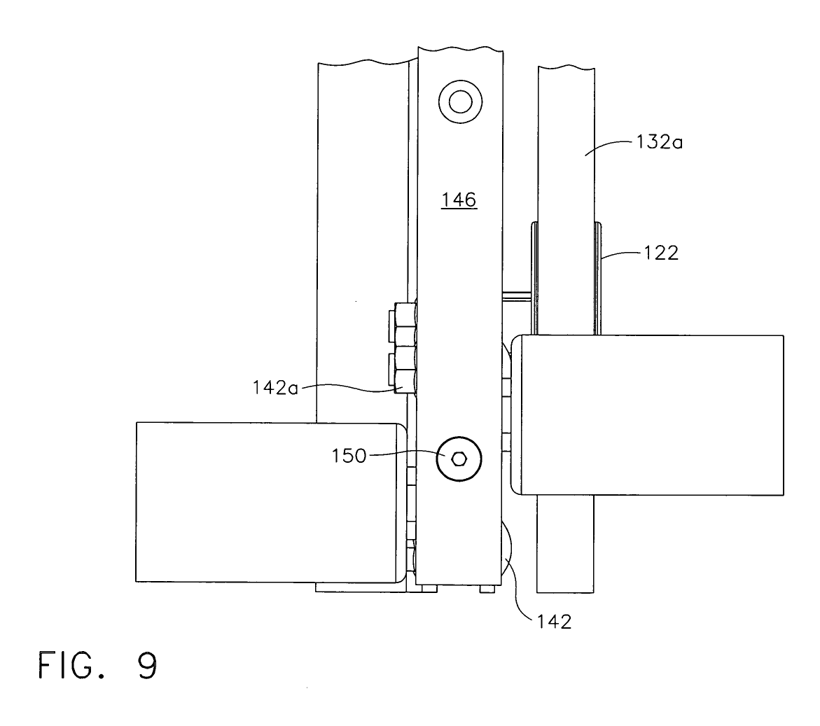

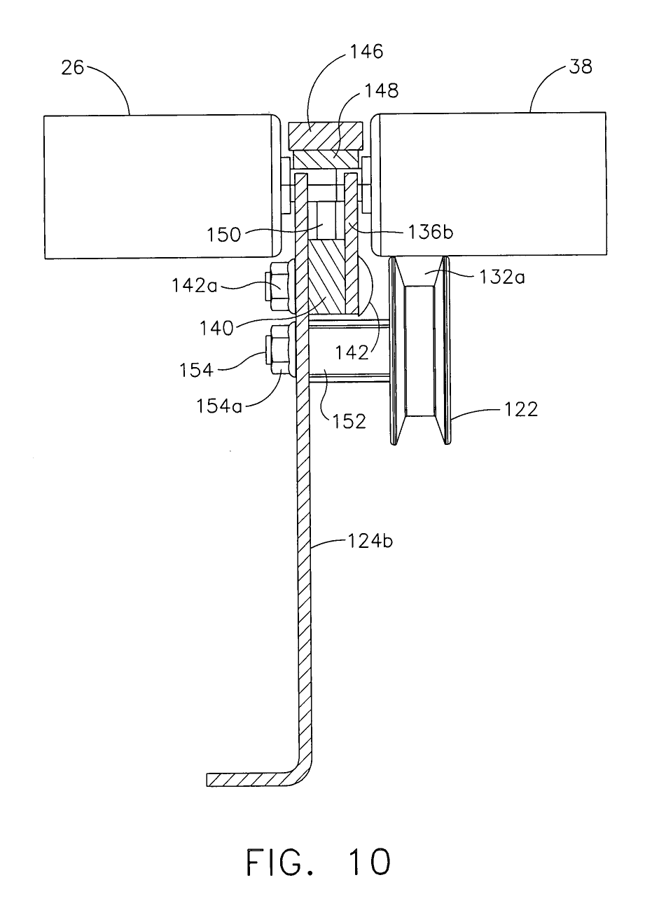

Referring also to FIGS. 9 and 10, a plurality of spacers 140 spaced apart longitudinally along inner frame 124b maintain mounting rail 136b in a lateral spaced apart relation to inner frame 124b. Mounting rail 136b and spacers 140 are secured in place by threaded fasteners 142, such as carriage bolts, and nuts 142a at spaced locations. Mounting rail 136b includes longitudinally extending openings 144 through which fasteners 142 extend into respective openings in inner frame 124b. The shape of openings 144 permit longitudinal adjustment of rollers 38. In the embodiment depicted, when mounting rail 136a (not shown in FIGS. 8-10) is mounted to inner frame 124a in the same longitudinally adjustable manner, the amount and direction of skew of center lane 22 may be adjusted by the relative positioning of mounting rails 136a and 136b.

As seen in FIGS. 8-10, the roller axles of the inner end of rollers 26 and of rollers 38 are held in place by cap 146 and spacer 148. The upper surface of cap 146 is slightly lower than the conveying surface defined by the upper tangent edge of rollers 26 and 38. The entrance and exit ends of cap 146 are tapered to avoid presenting an edge that might catch articles. Cap 146, made of any suitable material, such as metal, may be secured in place by threaded fasteners 150 which engage spacers 140. Spacer 140 and 148 may be made of any suitable material, such as HDPE. (It is noted that, in the embodiment depicted, the outside axles of rollers 26 on either outside lane 20 and 24 extend into complementarily shaped openings formed in outer frames 36a and 36b, needing no cap to hold them in place.)

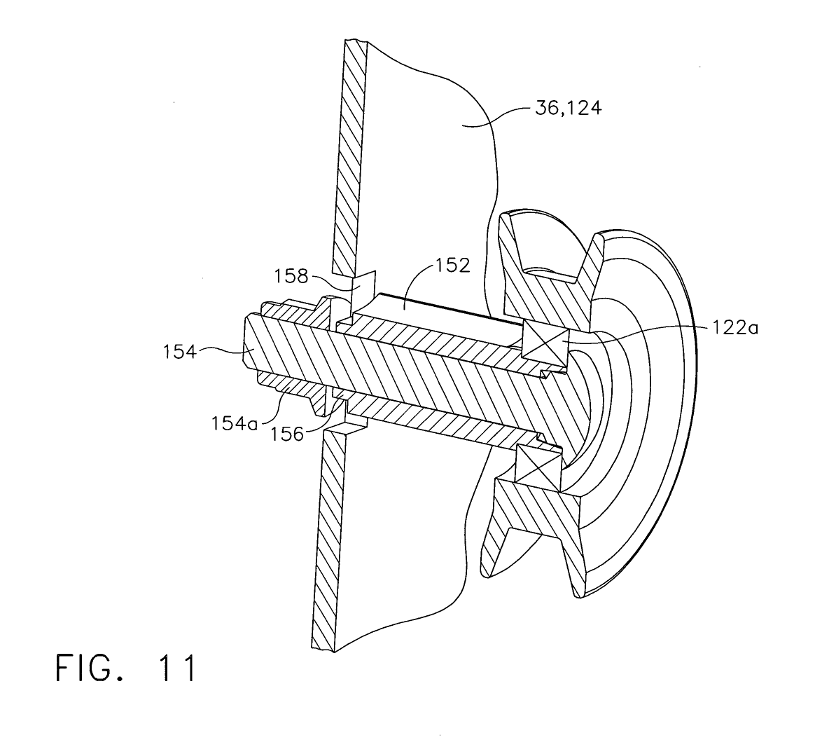

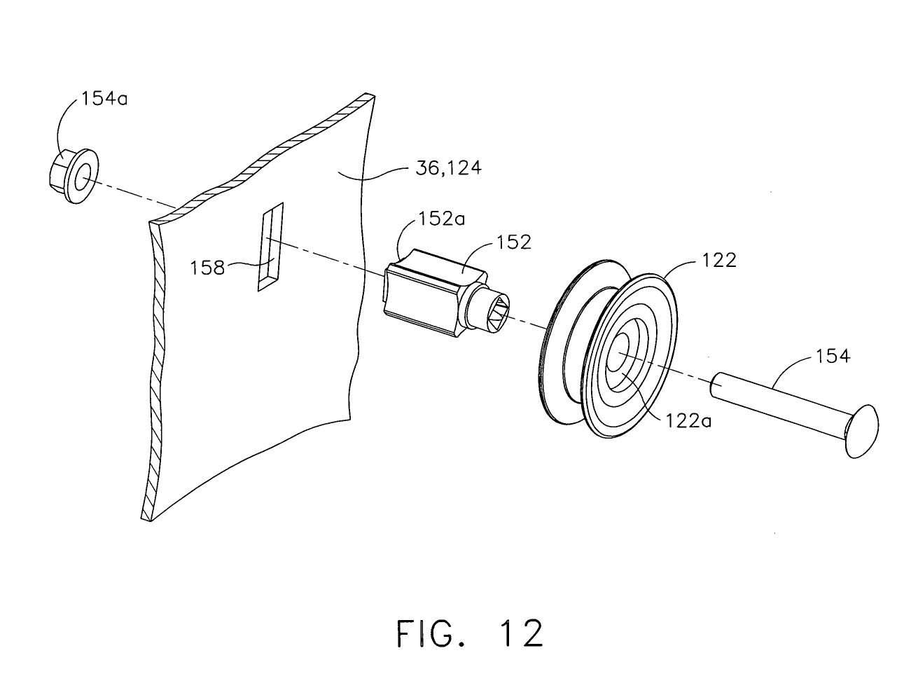

Referring particularly to FIG. 10, pressure sheave 122 is illustrated urging drive belt 132a against the lower surface of roller 38. Each sheave 122 of each lane 20, 22 and 24, is aligned in the gap between adjacent pairs of rollers 26 or 38, leaving alternating gaps between the rollers empty. Sheave 122 may be mounted in any suitable manner. Referring also to FIGS. 11 and 12, which illustrates a mounting configuration for sheave 122, sheave 122 is rotatably mounted to mounting base 152 through bearing 122a, which may be secured to frame member, 36 or 124, through carriage bolt 154. Mounting base 152 includes boss 152a, which in the embodiment depicted, is generally rectangular or square in shape, which is shaped complementary to opening 158 formed in frame member 36 or 124. Opening 158 extends vertically to allow vertical adjustment of sheave 122 to adjust the pressure of drive belt 132 against the rollers. The shape of boss 152a allows vertical movement of boss 152a within opening 158, but not rotation. Thus, the interface between this end of mounting base 152 and the frame prevents relative rotation while allowing vertical adjustment. The other end of mounting base 152 includes an internal configuration that is shaped complementarily to the rotation resistant configuration of the head of fastener 154, in the embodiment depicted, the square shape of the carriage bolt. This configuration resists relative rotation between fastener 154 and mounting base 152. The resistance to relative rotation of the interface between fastener 154 and mounting base 152 at the distal end of mounting base 152, combined with the resistance to relative rotation of mounting base 152 to frame 36 or 124 allows sheave to be adjusted and secured through nut 154a.

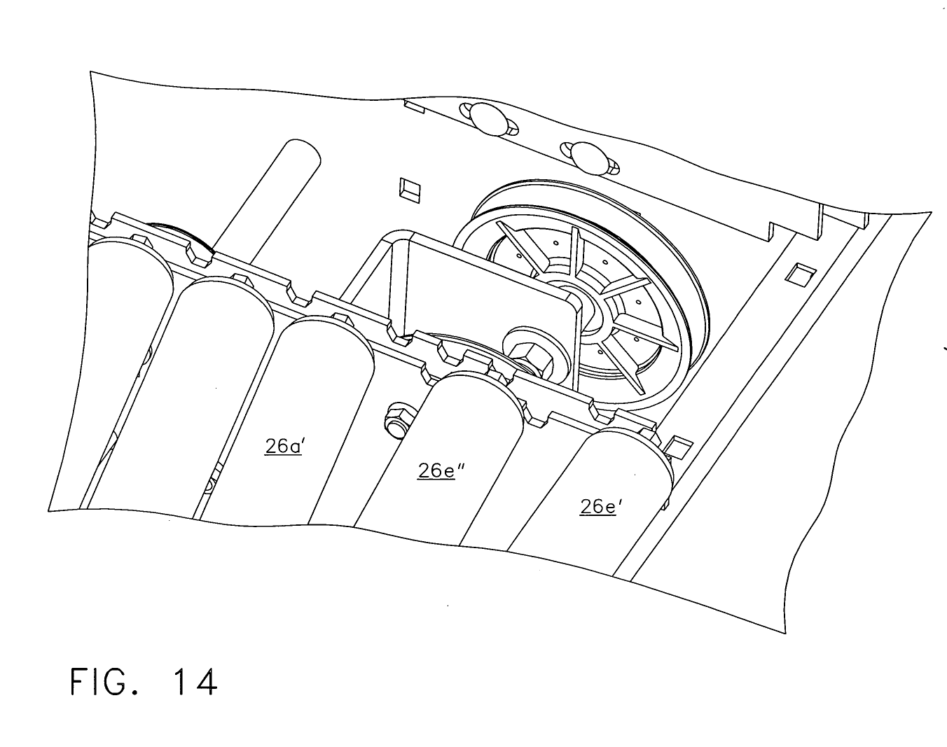

FIG. 13 illustrates openings 156 in inner frame 124b, for receiving the inner axle ends of outer rollers 26. Openings 156 are generally evenly spaced, with opening 156b disposed in-between spaced apart openings 156. Opening 156b is located to receive inner end axle of roller 26e″ when the rollers at the exit are fanned back. FIG. 14 illustrates roller 26e″ and adjacent rollers in their fanned orientation.

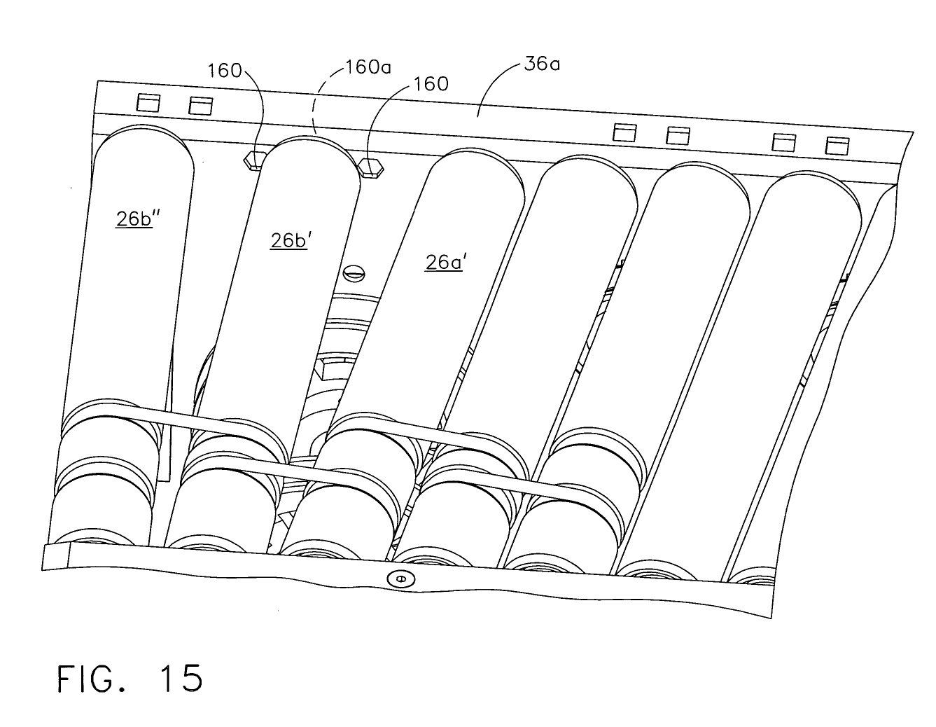

FIG. 15 illustrates openings 160 in outer frame 36, for receiving the outer ends of outer rollers 26. Openings 156 are evenly spaced, with opening 160a (not seen in FIG. 15) disposed in between spaced apart openings 160. Opening 160a is located to receive outer end axle of roller 26b′ when the rollers at the entrance are fanned out. As can be seen, O-belts may be located at the inner end of rollers 26.

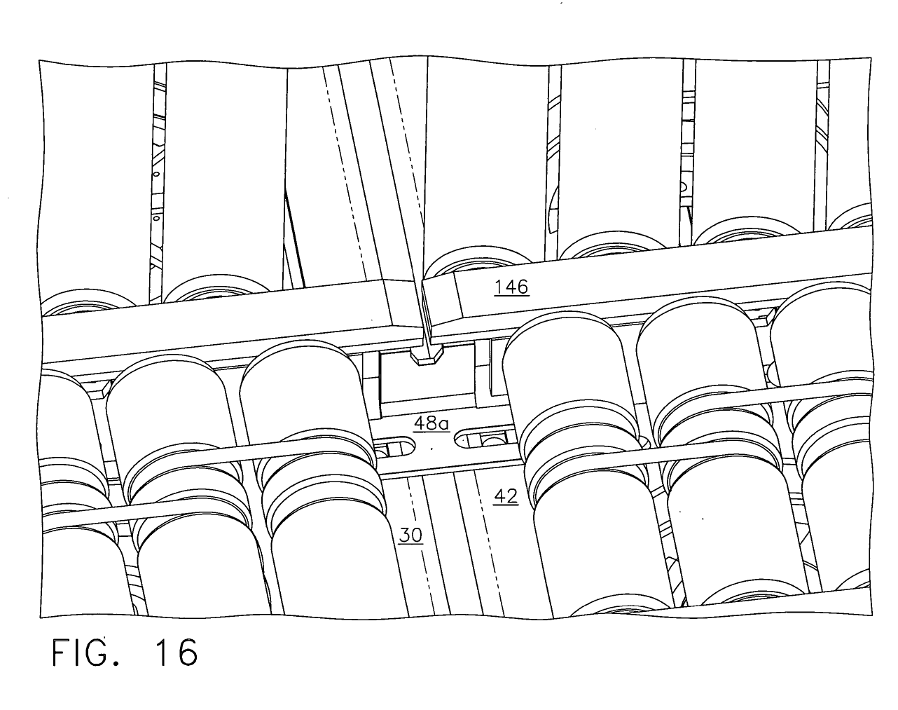

FIG. 16 illustrates bracket 48a bridging sections 4 and 6.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims submitted herewith.

1. A conveyor comprising:
a. a first lane extending in an longitudinal direction, said first lane comprising a first plurality of rollers which define a first upper conveying surface moving at a first speed;
b. a second lane extending in said longitudinal direction, said second lane being spaced apart laterally from said first lane, said second lane comprising a second plurality of rollers defining a second upper conveying surface moving at a second speed;
c. a third lane extending in said longitudinal direction and interposed between said first and second lanes, said third lane comprising a third plurality of rollers defining a third upper conveying surface moving at a third speed;
d. said first plurality of rollers being skewed toward said third lane; and
e. said second plurality of rollers being skewed toward said third lane.

2. The conveyor of claim 1, wherein said first lane includes at least one roller adjacent said first plurality of rollers which is not skewed.

3. The conveyor of claim 1, wherein said third plurality of rollers are skewed toward said first lane.

4. The conveyor of claim 1, wherein said first, second and third conveying surfaces are substantially coplanar with each other.

5. The conveyor of claim 1, wherein said rollers are wheels.

6. The conveyor of claim 1, wherein said rollers are tapered.

7. The conveyor of claim 1, wherein said rollers are cylindrical.

8. The conveyor of claim 1, wherein said rollers are driven.

9. The conveyor of claim 1, wherein said third speed is greater than said first speed.

10. The conveyor of claim 9, wherein said third speed is greater than said second speed.

11. The conveyor of claim 1, wherein said first and second speeds are approximately equal.

12. The conveyor of claim 11, wherein said third speed is greater than said first and second speeds.

13. A conveyor comprising:
a. at least a first and second sequentially arranged conveyor module, each conveyor module comprising:
i. a first lane extending in an longitudinal direction, said first lane comprising a first plurality of rollers which define a first upper conveying surface moving at a first speed;
ii. a second lane extending in said longitudinal direction, said second lane being spaced apart laterally from said first lane, said second lane comprising a second plurality of rollers defining a second upper conveying surface moving at a second speed;
iii. a third lane extending in said longitudinal direction and interposed between said first and second lanes, said third lane comprising a third plurality of rollers defining a third upper conveying surface moving at a third speed;
iv. said first plurality of rollers being skewed toward said third lane; and
v. said second plurality of rollers being skewed toward said third lane;
b. said first lanes of each module being longitudinally aligned with each other;
c. said second lanes of each module being longitudinally aligned with each other; and
d. said third lanes of each module being longitudinally aligned with each other.

14. The conveyor of claim 13, wherein said first, second and third speeds of said second module are respectively different from the first, second and third speeds of said first module.

15. The conveyor of claim 14, wherein said first, second and third speeds of said second module are respectively greater than the first, second and third speeds of said first module.

16. The conveyor of claim 13, wherein said at least a first and second sequentially arranged conveyor module comprises a third sequentially arranged module.

17. The conveyor of claim 16, wherein said first, second and third speeds of said third module are respectively greater than the first, second and third speeds of said second module.

18. The conveyor of claim 13, wherein said third plurality of rollers are skewed toward said first lane.
